(19) United States
(12) Patent Application Publication
(10) Pub. No.: US 2019/0138815 A1
(43) Pub. Date: May 9, 2019

(54) Method, Apparatus, User Terminal, Electronic Equipment, and Server for Video Recognition

(71) Applicant: UC Technology Co., Ltd., Beijing (CN)

(72) Inventors: Jiabao Dai, Beijing (CN); Peng Liu, Beijing (CN); Long Yang, Beijing (CN)

(73) Assignee: UC Technology Co., Ltd., Beijing (CN)

(21) Appl. No.: 16/131,468

(22) Filed: Sep. 14, 2018

(30) Foreign Application Priority Data
Nov. 6, 2017 (CN) 201711079980.9

(51) Int. Cl. G06K 9/00; G06K 9/32; H04N 21/234; H04N 21/4722; H04N 21/4728; G06F 17/30

(52) U.S. Cl. CPC G06K 9/00744; G06K 9/32; H04N 21/23418; H04N 21/4722; G06F 3/04842; G06F 17/30867; G06F 17/3079; G06F 17/30846; H04N 21/4728

(57) ABSTRACT

The present invention discloses a method, a device, a client-side apparatus, an electronic device and a server for video content recognition. The method comprises: acquiring a target image arbitrarily selected by a user in a video; sending a request for video content recognition to a server, wherein the request for video content recognition includes the target image; and receiving a result of video content recognition from the server. The result of video content recognition comprises information related to the target image and found via searches on a search engine. According to the present disclosure, the information related to the target image in a video arbitrarily selected by the user can be flexibly provided to the user.

### PRIORITY CLAIMS

The present application claims priority under the Paris Convention to Chinese Patent Application No. CN201711079980.9, titled Method, Apparatus, User Terminal, Electronic Device and Server for Video Recognition and filed on Nov. 6, 2017, the content of which is incorporated herein in its entirety.

### TECHNICAL FIELD

The present invention relates to the technical field of video content recognition, and more particularly, to a method, apparatus, user terminal, electronic device and server for video content recognition.

### BACKGROUND

With rapid development of network technologies, more and more users choose to watch videos via the Internet. For example, users can watch video programs of current events, local culture programs, and TV series through the Internet.

Users may be interested in some of the video content when watching a video. Users may wish to know more about the characters, articles, landscapes, etc., in that video. In particular, under certain circumstances, background information of the characters or articles in a video may be important for users/viewers to understand the content of the video. For example, a user sees an unknown character in the video, and is very keen to find out the background of the character. For another example, the user is interested in articles worn by a certain star character appeared in the video, such as the clothes or ornaments the star character wears, and wishes to find out more about the article or purchase the article.

In the prior art, usually, a video provider processes the video and sets identification information in the video, and a server of the video provider matches the identification information with the information stored in a preset database, in order to provide annotations. This approach cannot flexibly provide information requested by a user with respect to any character, article, or landscape in the video. Further, the scope of the annotations is limited, and is restricted to the information of the database of the video provider. For example, a user may wish to know the background information of a character in the video, but the annotations may only include information related to the articles in the video. As such, under many circumstances, prior art solutions cannot meet the needs of the users.

Therefore, the inventors believe that there is a need for better solutions with respect to at least one technical problem existing in the prior art.

### SUMMARY

One objective of the present disclosure is to provide a new technical solution for video content recognition.

According to a first aspect of the present disclosure, a method of video content recognition is provided. The method comprises: acquiring a target image arbitrarily selected by a user in a video; sending a request for video content recognition to a server, wherein the request for video content recognition contains the target image; and receiving a result of video content recognition from the server, wherein the result of video content recognition comprises information that is related to the target image and found via searches on a search engine.

Optionally, the method further comprises: acquiring search engine information that is set in a user terminal, wherein the search engine information identifies the search engine used for searching, and wherein the request for video content recognition further contains the search engine information.

Optionally, the search engine information is contained in a uniform resource locator (URL) of the request for video content recognition.

Optionally, acquiring a target image arbitrarily selected by a user in a video further comprises: detecting a click operation of the user on a function button that corresponds to an acquiring operation; pausing playing of the video; extracting a current video frame in the video as an image to be edited; and performing edit operation to the image to be edited to acquire the target image.

Optionally, acquiring a target image arbitrarily selected by a user in a video further comprises: receiving a preset click operation of the user, wherein the preset click operation is a click operation preset for video content recognition; and automatically acquiring the target image based on an operation point (or location) of the preset click operation.

Optionally, the playing of the video is uninterrupted when the target image is automatically acquired.

Optionally, the target image is acquired using the location or operation point of the click operation as the center and using a preset image size as the size of the target image.

Optionally, the result of video content recognition comprises: information of articles similar to the article or articles in the target image; or information associated to the target image or information associated to what is similar to the target image.

According to a second aspect of the present disclosure, there is provided a method for video content recognition, which comprises: receiving a request for video content recognition from a client-side apparatus, wherein the request for video content recognition contains a target image arbitrarily selected by a user in a video; acquiring a corresponding result of video content recognition by using a search engine based on the target image; and sending the result of video content recognition to the client-side apparatus, wherein the result of video content recognition comprises information searched via the search engine.

Optionally, the request for video content recognition further contains search engine information, and the search engine information identifies the search engine for searching.

Optionally, the search engine information is contained in a URL of the request for video content recognition.

Optionally, the method further comprises: recording the request for video content recognition and the result of video content recognition, wherein acquiring the corresponding result of video content recognition further comprises: acquiring the corresponding result of video content recognition based on at least one of the previous request for video content recognition and the previous result of video content recognition.

Optionally, the result of video content recognition comprises: information of articles similar to that in the target image; or information related to the target image or associated information similar to the target image.

According to a third aspect of the present disclosure, there is provided an apparatus for video content recognition, which comprises: a device for acquiring a target image arbitrarily selected by a user in a video; a device for sending a request for video content recognition to a server, wherein the request for video content recognition contains the target image; and a device for receiving a result of video content recognition from the server, wherein the result of video content recognition comprises information related to the target image and found via searches on a search engine.

According to a fourth aspect of the present disclosure, there is provided an apparatus for video content recognition, which comprises: a device for receiving a request for video content recognition from a user terminal, wherein the request for video content recognition contains a target image arbitrarily selected by a user in a video; a device for acquiring a corresponding result of video content recognition by using a search engine based on the target image; and a device for sending the result of video content recognition to the user terminal, wherein the result of video content recognition comprises information related to the target image and found through searches via the search engine.

According to a fifth aspect of the present disclosure, there is provided a client-side apparatus, comprising the apparatus for video content recognition according to the third aspect of the present disclosure, or designed for performing any operation in the method of video content recognition according to the first aspect of the present disclosure.

According to a sixth aspect of the present disclosure, there is provided a server-side apparatus, comprising the apparatus for video content recognition according to the fourth aspect of the present disclosure, or designed for performing any operation in the method of video content recognition according to the second aspect of the present disclosure.

According to a seventh aspect of the present disclosure, there is provided an electronic device, comprising the client-side apparatus according to the fifth aspect of the present disclosure, or comprising a memory and a processor, wherein the memory stores an executable instruction, and the executable instruction controls the processor to execute any operations in the method for video content recognition according to the first aspect of the present disclosure during operation of the electronic device.

According to an eighth aspect of the present disclosure, there is provided a server, comprising the server-side apparatus according to the sixth aspect of the present disclosure, or comprising a memory and a processor, wherein the memory stores executable instructions, and the executable instructions control the processor to execute any operation in the method for video content recognition according to the second aspect of the present disclosure during operation of the server.

According to an embodiment of the present disclosure, information related to the target image can be flexibly provided to the user according to the target image arbitrarily selected by the user in the video.

Other features and advantages of the present invention will become apparent from the following detailed description of exemplary embodiments of the present invention with reference to the accompanying drawings.

### BRIEF DESCRIPTION OF THE DRAWINGS

The accompanying drawings, which are incorporated in and constitute a part of the description, illustrate embodiments of the present invention and, together with the description thereof, serve to explain the principles of the present invention.

FIG. 1 shows a schematic flowchart of a method according to a first embodiment of the present disclosure.

FIG. 2 shows a schematic block diagram of a client-side apparatus according to the first embodiment of the present disclosure.

FIG. 3 shows a schematic block diagram of an electronic device according to the first embodiment of the present disclosure.

FIG. 4 shows a schematic flowchart of a method according to a second embodiment of the present disclosure.

FIG. 5 shows a schematic block diagram of a server-side apparatus according to the second embodiment of the present disclosure.

FIG. 6 shows a schematic block diagram of the server according to the second embodiment of the present disclosure.

### DETAILED DESCRIPTION

Various exemplary embodiments of the present invention will now be described in detail with reference to the accompanying drawings. It should be noted that the relative arrangement, numerical expressions and numerical values of the components and steps set forth in these examples do not limit the scope of the invention unless otherwise specified.

The following description of at least one exemplary embodiment is merely illustrative and is not intended as a limitation to the present invention and its application or use.

Techniques, methods, and device known to those of ordinary skill in the relevant art may not be discussed in detail but where appropriate, the techniques, methods, and device should be considered as part of the description.

Among all the examples shown and discussed herein, any specific value should be construed as merely illustrative and not as limiting. Thus, other examples of exemplary embodiments may have different values.

It should be noted that similar reference numerals and letters denote similar items in the accompanying drawings, and therefore, once an item is defined in a drawing, there is no need for further discussion in the subsequent accompanying drawings.

Respective embodiments and examples according to the present disclosure are described with reference to the accompanying drawings in the following.

### First Embodiment

<Method>

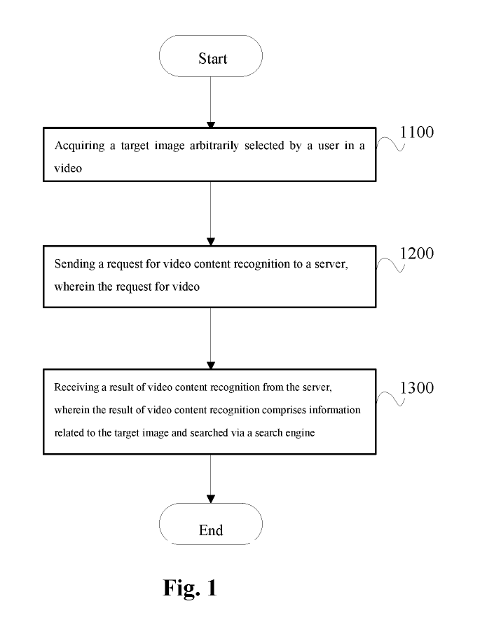

FIG. 1 shows a schematic flowchart of a method according to a first embodiment of the present disclosure.

As shown in FIG. 1, in step 1100, a target image arbitrarily selected by a user in a video is acquired. Here, the target image may be arbitrarily selected by the user without extra or additional pre-processing of the video. The selected target image may be the entire video frame, or may be part of the video frame.

In one example, a function button corresponding to the operation of acquiring a target image may be provided on a video-playing interface. During video playing, the user may click on the function button to acquire a target image. The video may be paused. A current video frame in the video is extracted as the image to be edited. Edit operation may be performed on the extracted image to obtain the target image.

For example, in the process of watching the video, the user may become interested in a certain actor in the video. The user clicks the function button corresponding to the acquiring operation on the video playing interface. When the client-side apparatus (or client side application) that is equipped with a function of video content recognition detects the user's click operation on the function button, the playing of the video may be paused. The client-side apparatus may be, for example, a browser, a video player, etc. Next, the client-side apparatus extracts the current video frame in the video as an image to be edited. The user performs editing operation on the extracted image, or the client-side apparatus automatically performs editing on the extracted image. For example, the client-side apparatus may capture part of the image containing the actor in the extracted image as the target image. In one embodiment, the user may click on the function button, and the client-side apparatus generates a request for video content recognition to send the target image to a server.

In another example, the target image arbitrarily selected by the user may be acquired by a preset click operation. For example, the client-side apparatus may detect the preset click operation of the user. The preset click operation may be a double-click, a sliding or a multi-finger click, etc., preset or pre-defined for video content recognition. The target image may be automatically acquired based on an operation point of the preset click operation, for example, the point or the location where the click operation takes place.

For example, after the preset click operation of the user is received or detected, based on the operation point of the preset click operation, the target image centering on the operation point may be acquired based on a preset size of the target image. For example, suppose the following parameters are given: the operation point is C and the coordinates of the operation point C are (m, n). The current video frame of the video may be taken as a reference image, and a rectangle centering on the point C with a length w and a height h is captured automatically. The coordinates of the upper left corner of the rectangle are (m−w/2, n+h/2), and the coordinates of the lower right corner of the rectangle are (m+w/2, n−h/2). The image inside the rectangular portion is determined as the target image. In some embodiments, the playing of the video may be paused when the target image is being acquired. In other embodiments, when the target image is automatically acquired, the playing of the video may be uninterrupted. Acquiring a target image without interruption can improve user experience.

It should be noted that the click operation that is preset for video content recognition may be any operation on the video playing interface, for example, a single-click, a double-click, a sliding, etc., and is not limited to the specific examples described herein.

For example, the click operation may be preset to a double-click operation. While watching the video, the user becomes interested in a certain actor in the video. The user triggers the client-side apparatus to acquire the target image by double-clicking the area featuring the actor on the video playing interface. After receiving the double-click operation of the user, the client-side apparatus automatically captures a rectangle with length w and height h as the target image centering on the operation point of the double-click operation of the user. The client-side apparatus also generates a request for video content recognition and sends the request along with the target image to a server.

In referring to FIG. 1, in step 1100, a target image arbitrarily selected by a user in a video is acquired.

In step 1200, the request for video content recognition is sent to the server. The request for video content recognition includes the target image.

In step 1300, a result of video content recognition is received from the server. The result of video content recognition includes information related to the target image and obtained via searches on a search engine.

In this embodiment, the target image arbitrarily selected by the user is used to acquire information related to the target image from the search engine by the server. This approach is different from any existing prior art in that information related to the target image is obtained by the server using search engines. This approach is more flexible compared to any existing approaches. The search result obtained using search engines is not limited to the content in the database maintained by a specific provider. Furthermore, this approach also provides more flexibility in server configuration. For example, the server may be configured to use different search engines to obtain result for a video content recognition request for different users, based on the specific requirements of a user request, to further improve user experience.

In some embodiments, the search engine information may be set by the client-side apparatus. The search engine information identifies the search engine to be used in finding information in response to a video recognition request. Generally speaking, the search engine information may be set in advance in the client-side apparatus or set to a default search engine. When the request for video content recognition is sent to a server, the request for video content recognition may also contain the search engine information. The search engine may be a commercial search engine or a content search engine. For example, one exemplary commercial search engine may be an e-commerce search engine that is configured to search for article information related to the article or articles contained in the target image. A content search engine is configured to search for related information associated with the content of the target image.

Search engine information identifies the search engine to be used by the server and conveys the identity of the search engine to the server. For example, the search engine information of the commercial search engine is A, and the search engine information of the content search engine is B. In some embodiments, when the request for video content recognition is sent to the server, the request contains the search engine information. For example, the search engine information may be included in the URL of the request for video content recognition. Upon receiving the URL, the server uses the corresponding search engine to search for information related to the target image.

In some embodiments, the search engine information may be determined by user selection when the target image is acquired. For example, when the user clicks the function button for acquiring the target image or performs the preset click operation, one or more search engine options may be provided to the user for selection. In this way, the user's interests may be reflected in his or her selection of search engine during run time, for example, the background information of the character or article purchase information, thereby allowing the server to return more accurate results of video content recognition.

The result of the video content recognition request may include information related to articles information similar to the article or articles in the target image. The result of video content recognition may also include related information similar to the information associated with the target image.

For example, the article information may be a result of searches on the search engine of a shopping website such as Taobao. For instance, the target image contains items such as clothing, ornaments, furniture, household supplies, or other articles. The returned result for the video content recognition request may comprise information related to these articles. The article information may comprise information such as a brand name, a price and a purchase link of an article in the target image. For example, the associated information may be the result searched on an information search engine such as Baidu. The target image contains, for example, characters, landscapes, or the like. The result of the video content recognition request comprises information related to such content. For example, the associated information may comprise information such as introduction of the characters, the landscapes, and/or geographic position navigation.

In this embodiment, the request for video content recognition can be sent to the server based on the target image arbitrarily selected by the user in the video. The server conducts searches on the search engine or engines identified in the request, and returns the search result to the user or the client-side apparatus. In this way, the server can be flexibly configured to use different search engines. In addition, the search results to be returned to the user are not limited to the content in the database of the server.

<Device>

Those skilled in the art should appreciate that in the field of electronic technology, the above method can be embodied in a product by means of software, hardware, or combination of the software and the hardware. Those skilled in the art can make a device for video content recognition based on the method disclosed above. The device comprises means (i.e., hardware components such as hard-coded circuits or CPU loaded with executables, software programs, or combination of hardware and software) for performing respective operations in the method for video content recognition according to the above embodiment. For example, the device comprises means for acquiring a target image arbitrarily selected by a user in a video; means for sending a request for video content recognition to a server. The request for video content recognition contains the target image. The device further comprises means for receiving a result of video content recognition from the server. The result of video content recognition comprises information related to the target image and retrieved via searches on a search engine.

<Client-Side Apparatus>

At least one of the embodiments according to the present disclosure can be implemented in the client-side apparatus (or client side application) such as a video browser and a video player.

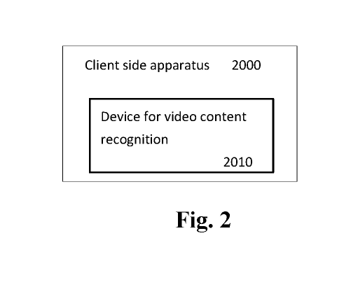

FIG. 2 shows a schematic block diagram of a client-side apparatus according to the first embodiment of the present disclosure. As shown in FIG. 2, the client-side apparatus 2000 comprises a device for video content recognition 2010. The device for video content recognition 2010 may be implemented according to the above embodiment.

In addition, as mentioned above, the client-side apparatus may also be made based on the method mentioned above, and may be designed to execute the steps in the solution according to the embodiment or embodiments described above with reference to FIG. 1.

It is well-known to those skilled in the art that, with the development of electronic information technologies such as large-scale integrated circuit technologies, and the trend that software functions are being realized as hardware designs, it becomes difficult to distinguish between software and hardware in computer systems, since any operation that can be realized in software can also be hard-wired in hardware, and any instruction that can be carried out by hardware can also be implemented as software instruction. Whether to implement a function of a machine using software or hardware solution depends on technical and non-technical factors such as prices, speed, reliability, storage capacity, upgrade cycle etc. For those skilled in the art, software and hardware implementations are equivalent to each other. Those skilled in the art can select software and/or hardware to realize the above solutions according to their specific needs. Therefore, the specific software or hardware used to implement the solutions and methods disclosed herein will not be defined here.

<Electronic Device>

Any one of the above embodiments can be implemented in an electronic device such as a mobile phone and a tablet computer. For example, the electronic device may comprise a device for video content recognition disclosed above or comprise the client-side apparatus disclosed above.

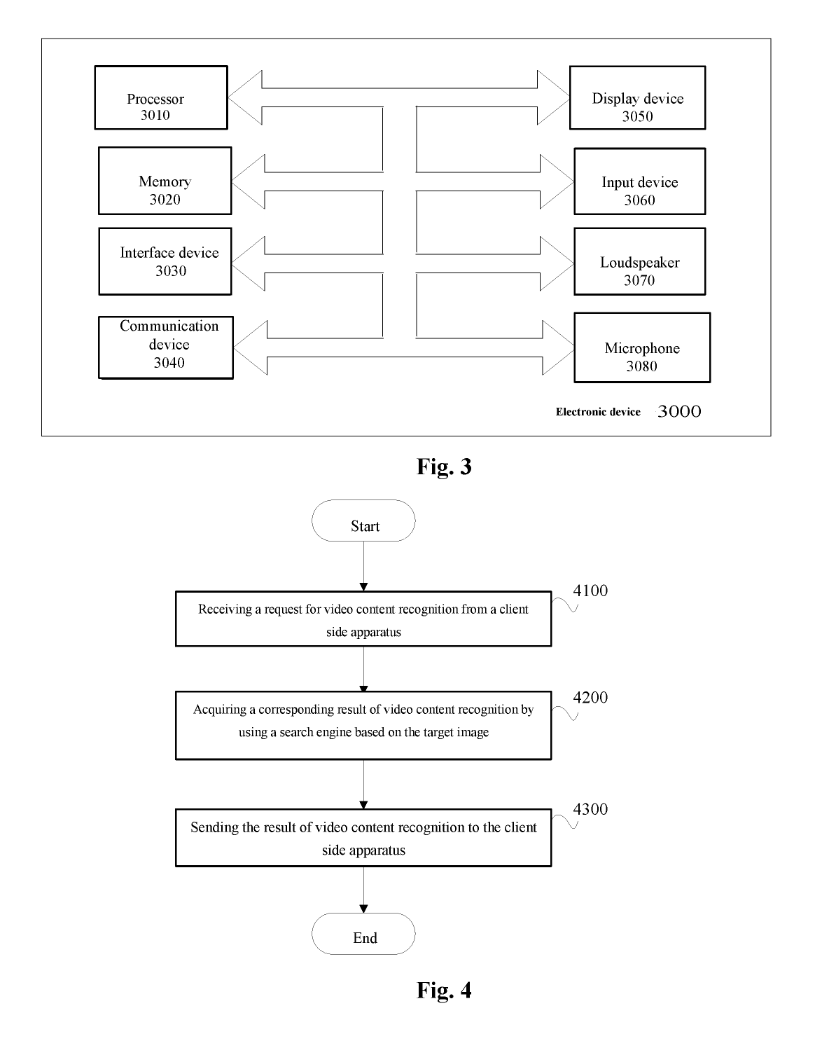

FIG. 3 shows a schematic block diagram of an electronic device according to some embodiments of the present disclosure. As shown in FIG. 3, the electronic device 3000 may include a processor 3010, a memory 3020, an interface device 3030, a communication device 3040, a display device 3050, an input device 3060, a loudspeaker 3070, a microphone 3080, etc.

The processor 3010 may be, for example, a central processing unit (CPU), a micro processing unit (MCU), or the like. The memory 3020 includes, for example, a read only memory (ROM), a random access memory (RAM), a nonvolatile memory such as a hard disk, or the like. The interface device 3030 includes, for example, a USB interface, a headphone interface, or the like.

The communication device 3040 for example may be wired or wireless communication equipment.

The display device 3050 may be, for example, a liquid crystal display screen, a touch display screen, or the like. The input device 3060 may include, for example, a touch screen, a keyboard, or the like. The user can input/output voice messages via the loudspeaker 3070 and the microphone 3080.

The electronic device as shown in FIG. 3 is merely illustrative and is no way intended to impose any limitation on the present invention and its application or use.

In such embodiment, the memory 3020 is configured to store instructions. When the electronic device 3000 operates, the instructions are used for controlling the processor 3010 to perform the operations in the methods for video content recognition previously described with reference to FIG. 1. It should be appreciated by those skilled in the art that although a plurality of devices is illustrated in FIG. 3, the exemplary methods disclosed herein may relate only to a portion of the devices, for example, the processor 3010, the memory 3020 and the like. Those skilled in the art may design the instructions in accordance with the solutions disclosed in the present disclosure. How to control the processor to perform operations through the instructions is well-known in the art and is not described in detail herein.

### Second Embodiment

<Method>

FIG. 4 shows a schematic flowchart of a method according to a second embodiment of the present disclosure.

As shown in FIG. 4, in step 4100, a request for video content recognition from a client-side apparatus is received, wherein the request for video content recognition contains a target image arbitrarily selected by a user in a video.

In one example, the request for video content recognition may further contain search engine information set by the user in the client-side apparatus. The search engine information identifies a search engine to be used for searching. For example, the search engine information is contained in a URL of the request for video content recognition.

In step 4200, a result of video content recognition in response to the request of the video content recognition corresponding to the target image is acquired by using the search engine.

Here, the search engine information may be written in a URL parameter of the request for video content recognition. The search request for video content recognition is sent to a background service interface by using the Hypertext Transfer Protocol (HTTP).

After the background service interface receives the search request, the search engine information in the search request is extracted for sending the search request to a corresponding search engine interface. For example, after the search engine receives the search request, feature extraction may be performed on the target image. The content most similar to the target image is acquired as the corresponding result of video content recognition by using a big data algorithm. The description on the search engine is omitted here.

In step 4300, the result of video content recognition is sent to the client-side apparatus. The result of video content recognition comprises information related to the target image and found or retrieved via searches on the search engine. For example, the result of video content recognition may comprise the information related to articles similar to the article or articles in the target image, or associated information similar to the target image.

If the target image contains the goods or merchandise, for example, clothes, ornaments, furniture, household supplies and other articles, the result of video content recognition comprises article information similar to these articles. The article information may comprise, for example, information such as a brand name, a price and a purchase link. If the target image contains contents such as characters, landscapes, and the like. The result of video content recognition may comprise the information associated with or related to these contents, or associated information similar to these contents. For example, the associated information may comprise information such as introductions of the characters, introduction on the landscapes or geographic position navigation.

In one example, in order to compile a user profile and achieve precise content pushing and commercialized service recommendation for users, the server may also record the search behavior of a user while sending the result of video content recognition to the client-side apparatus. For example, the server may record the request for video content recognition and the result of video content recognition. For example, when the corresponding result of video content recognition is being acquired, the corresponding result of video content recognition may be acquired based on at least one of a previous request for video content recognition and a previous result of video content recognition.

In one embodiment, based on the received request for video content recognition containing the target image arbitrarily selected by the user, the server acquires the result of video content recognition corresponding to the target image by using the search engine and returns the result to the client-side apparatus, so as to provide information related to the target image to the user who is interested in finding out more about the target image. The present disclosure teaches a server that can be more flexibly configured than prior art.

<Device>

Those skilled in the art should understand that in the field of electronic technologies, the above method or methods may be embodied in a product by means of software, hardware, or combination of the software and the hardware. Those skilled in the art could easily produce a device for video content recognition based on the methods disclosed above. The device comprises means for executing respective operations in the methods for video content recognition according to the above-disclosed embodiments. For example, the device comprises hardware and/or software means for receiving a request for video content recognition from a client-side apparatus, wherein the request for video content recognition contains a target image arbitrarily selected by a user in a video; means for acquiring a corresponding result of video content recognition by using a search engine based on the target image; and means for sending the result of video content recognition to the client-side apparatus, wherein the result of video content recognition comprises information related to the target image and found via searches on the search engine. Herein the term “means” may refer to processors, processing circuits, CPUs, micro-processors that are either hard-coded or store or run software executables. The term “means” may also refer to software programs or software modules that are implemented to achieve certain functions.

<Server-Side Apparatus>

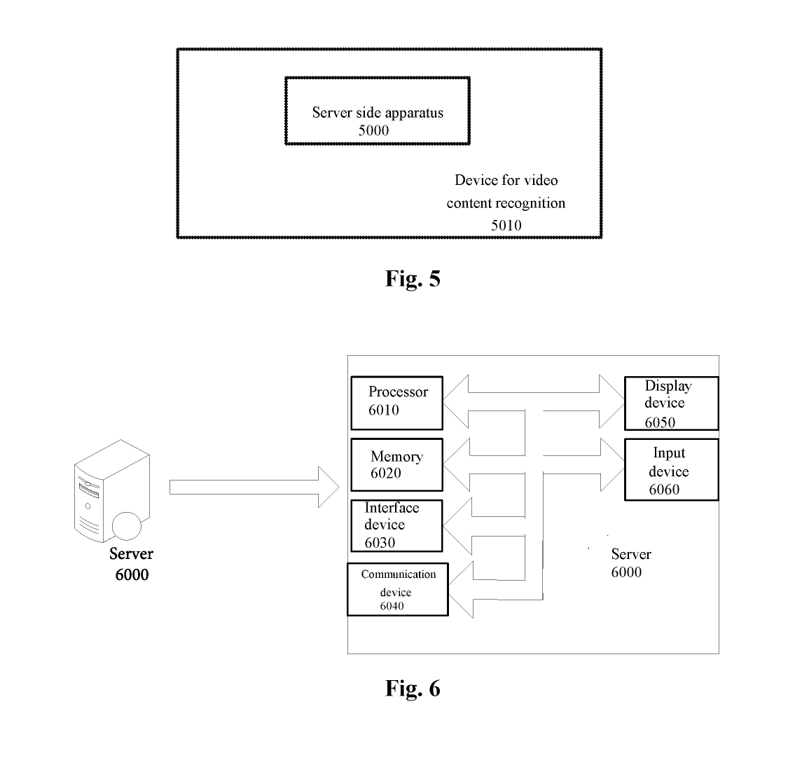

FIG. 5 shows a schematic block diagram of a server-side apparatus according to the second embodiment of the present disclosure. As shown in FIG. 5, the server-side apparatus 5000 comprises a device for video content recognition 5010. The device for video content recognition 5010 may be the device for video content recognition configured according to the above-disclosed embodiment.

In addition, as mentioned above, a server-side apparatus may also be produced based on the methods described above, and it can be designed to execute the steps in the solution according to the embodiments described above with reference to FIG. 4.

<Server>

The server here may be a server comprising the above server-side apparatus.

In addition, FIG. 6 shows a schematic block diagram of another server according to the second embodiment of the present disclosure. As shown in FIG. 6, the server 6000 may include a processor 6010, a memory 6020, an interface device 6030, a communication device 6040, a display device 6050, an input device 6060, and the like. Although the server may also include a loudspeaker, a microphone and the like, these parts are not related to the present disclosure, and are omitted in FIG. 6.

The processor 6010 may be, for example, a central processing unit (CPU), a micro processing unit (MCU), or the like. The memory 6020 includes, for example, an ROM (read-only memory), an RAM (random-access memory), a non-volatile memory such as a hard disk, or the like. The interface device 6030 includes, for example, a USB interface, a serial interface, or the like.

The communication device 6040 for example may be wired or wireless communication device.

The display device 6050 is, for example, a liquid crystal display screen, a touch display screen, or the like. The input device 6060 may include, for example, a touch screen, a keyboard, or the like.

The server as shown in FIG. 6 is merely illustrative and is not intended to impose any limitation on the present disclosure and its application or use.

In some embodiments, the memory 6020 is configured to store instructions. When the server 6000 operates, the instructions are used for controlling the processor 6010 to perform the operations in the methods for video content recognition described previously with reference to FIG. 4. It should be appreciated by those skilled in the art that although a plurality of devices is illustrated in FIG. 6, the present disclosure may relate only to a portion of the devices, for example, the processor 6010, the memory 6020 or the like. Those skilled in the art may design instructions in accordance with the solution disclosed in the present disclosure. How to control the processor to perform operations through the instructions is well-known in the art, therefore is not described in detail herein.

It is well-known to those skilled in the art that, with the development of electronic information technologies such as large-scale integrated circuit technologies, and the trend that software functions are being realized in hardware design, it becomes difficult to distinguish between software and hardware in computer systems, since any operation that can be realized in software can also be hard-wired in hardware, and any instruction that can be carried out by hardware can also be implemented as software programs. Whether to implement a function of a machine using software or hardware solution depends on technical and non-technical factors such as prices, speed, reliability, storage capacity, upgrade cycle etc. For those skilled in the art, software and hardware implementations are equivalent of each other. Those skilled in the art can select software and/or hardware to implement the above-described solutions according to their specific requirements. Therefore, the specific software or hardware used to implement the solutions and methods disclosed herein will not be defined here.

### Examples

The user may be interested in a certain part of the content in a video in the process of watching the video by using the client-side apparatus. For example, the user sees an unknown person whom the user becomes interested in or desires to purchase clothes or ornaments worn by a character in the video. To find out more, the user can use the function of video content recognition on the client-side apparatus.

For example, the user may trigger the function of video content recognition of the client-side apparatus by clicking a function button designed for the purpose of acquiring information related to the character or the articles worn by the character. When the click operation of the user on the function button is detected by the client-side apparatus, the playing of the video may be paused. A current video frame in the video is extracted as an image to be edited. Editing operation is performed on the extracted image, to obtain the target image.

In another example, the user can also trigger the function of video content recognition of the client-side apparatus by a preset click operation. For example, after the client-side apparatus receives the double-click operation of the user, the target image of the preset size is automatically acquired, centering on an operation point of the double-click operation. Optionally, in the process of automatically acquiring the target image, the playing of the video may be interrupted or uninterrupted.

For example, the preset click operation may be a double-click operation. In the process of watching the video, the user sees a character that he becomes interested in and double-clicks in a display area of the character. After receiving the double-click operation, the client-side apparatus automatically captures a rectangle with a length w and a height h and the rectangle becomes the automatically acquired target image with the operation point of the double-click operation as the center of the image.

After the client-side apparatus acquires the target image, the request for video content recognition is sent to the server. The request for video content recognition may be sent to the server under the HTTP protocol. The request for video content recognition contains the target image.

In one example, the client-side apparatus may obtain or retrieve the search engine information set by the user in the client-side apparatus. Correspondingly, the request for video content recognition may also comprise the search engine information. In a practical application, the search engine information may be contained in the URL of the request for video content recognition.

After the server receives the request for video content recognition from the client-side apparatus, the target image is sent to the corresponding search engine. The search engine acquires the corresponding result of video content recognition based on the target image. For example, the search engine performs feature extraction on the target image. The result of video content recognition most similar or most related to the target image is obtained by using the search engine and a big data algorithm. The search engine is not the focus of the present disclosure, and is not described in detail herein.

It should be noted that the search engine may be either a content search engine or a commercial search engine. A content search engine is configured to search for associated information related to the content in the target image. A commercial search engine is configured to search for article information related to the articles in the target image.

For example, the content of the target image may feature a character who wears certain outfit or ornaments. To search on the commercial search engine, e.g., e-commerce search engine, the corresponding acquired result of video content recognition may contain information such as the brand name, the price and the purchase link of the outfit and/or ornaments worn by the character. To search on the content search engine, the corresponding acquired result of video content recognition may contain information such as introductory information about the character.

After acquiring the result of video content recognition from the search engine, the server sends the result of video content recognition to the client-side apparatus under the HTTP protocol.

In addition, the server may also keep a record of the request for video content recognition and the result of video content recognition, to compile a profile of the user as a basis for implementing or improving precise content pushing and commercialized service recommendation for the user in the future.

In the examples discussed above, based on the target image arbitrarily selected by the user in the video, the information related to the target image that is of interest to the user is retrieved to be provided to the user, thereby improving user experience.

Here, the server may serve as an intervening device between the client-side apparatus and the search engine, thereby providing a more flexible way for obtaining video content recognition results.

The present disclosure may be a device, a method and/or a computer program product. The computer program product may include a computer-readable storage medium with computer-readable program instructions stored thereon for cause a processor to realize the aspects of the present disclosure.

The computer-readable storage medium may be a tangible device that can retain and store instructions for use by an instruction executing device. The computer-readable storage medium may be, for example, but is not limited to, an electric storage device, a magnetic storage device, an optical storage device, an electromagnetic storage device, a semiconductor storage device, or any suitable combination thereof. A non-exhaustive list of more specific examples of the computer-readable storage medium include the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disc (DVD), a memory stick, a floppy disk, a mechanical encoded device such as a punch-card or raised structures in a groove having instructions stored thereon, and any suitable combination thereof. A computer-readable storage medium as used herein is not to be interpreted as being transitory signals per se, such as radio waves or other freely propagated electromagnetic waves, electromagnetic waves propagating through a waveguide or other transmission media (e.g., light pulses passing through a fiber-optic cable), or electrical signals transmitted through a wire.

Computer-readable program instructions described herein may be downloaded from a computer-readable storage medium to respective computing/processing devices or to an external computer or external storage device via a network, such as the Internet, a local area network, a wide area network and/or a wireless network. The network may include copper transmission cables, fiber-optic transmission, wireless transmission, routers, firewalls, switches, gateway computers and/or edge servers. A network adapter card or network interface in each computing/processing device receives computer-readable program instructions from the network and forwards the computer-readable program instructions to be stored in the computer-readable storage medium within the respective computing/processing device.

Computer-readable program instructions for carrying out operations of the present invention may be assembly instructions, instruction set architecture (ISA) instructions, machine instructions, machine-dependent instructions, microcode, firmware instructions, state setting data, or either source codes or object codes written in any combination of one or more programming languages, including object-oriented programming languages such as Smalltalk, C++ and the like, as well as conventional procedural programming languages, such as the “C” programming language or similar programming languages. The computer-readable program instructions may be execute entirely on a user's computer, partly on the user's computer, as a stand-alone software package, partly on the user's computer and partly on a remote computer, or completely executed on the remote computer or a server. When the remote computer is referred to, the remote computer may be connected to a user computer via any kind of network, including a local area network (LAN) or a wide area network (WAN), or may be connected to an external computer (e.g., via the Internet provided by an Internet service provider). In some embodiments, by customizing electronic circuitry including, for example, a programmable logic circuitry, a field programmable gate array (FPGA) or a programmable logic array (PLA) by utilizing state information of the computer-readable program instructions, the electronic circuit may execute the computer-readable program instructions so as to implement various aspects of the present invention.

Various aspects of the present invention are described herein with reference to flow charts and/or block diagrams of the method, device (system) and computer program product according to the embodiments of the present invention. It should be understood that each block of the flow charts and/or the block diagrams, as well as the combinations of all blocks in the flow charts and/or in the block diagrams, may be implemented by computer-readable program instructions.

These computer-readable program instructions may be provided to a processor of a general purpose computer, a special purpose computer, or other programmable data processing devices to produce a machine, so that these instructions, when executed via the processor of the computer or other programmable data processing apparatuses, create means for implementing the functions/acts specified in one or more blocks in the flow charts and/or in the block diagrams. These computer-readable program instructions may also be stored in a computer-readable storage medium that can cause the computer, a programmable data processing device and/or other devices to operate in a particular manner, such that the computer-readable medium having instructions stored thereon includes an article of manufacture including instructions which implement functions/acts specified in one or more blocks in the flow charts and/or in the block diagrams.

The computer readable program instructions may also be loaded onto a computer, other programmable data processing apparatuses or other devices, to cause a series of operational steps to be performed on the computer, other programmable data processing apparatuses or other devices, to produce a computer-implemented process, such that the instructions which execute on the computer, other programmable apparatus, or other device implement the functions/acts specified one or more blocks in the flowchart and/or in the block diagram.

The flowcharts and block diagrams in the accompanying drawings show the structure, functionality and operation of possible implementations of systems, methods and computer program products according to various embodiments of the present invention In this regard, each block in the flowcharts and block diagrams may represent a module, a program segment or a part of instructions, which comprises one or more executable instructions for implementing the specified logical functions. It should also be noted that in some alternative implementations, the function described in a block may be occurring in a sequence difference from that described in the drawings. For example, two consecutive blocks may, in fact, be executed substantially in parallel, and sometimes may be executed in an inverse sequence, depending on the related functions. It should also be noted that each block or a combination of the blocks in the flowcharts and/or block views may be implemented by special purpose hardware-based systems for performing the specified functions or acts, or combinations of special purpose hardware and computer instructions. It is well known to those skilled in the art that the implementations using hardware, using software or using a combination of software and hardware can be equivalents to each other.

Various embodiments of the present invention have been described above. The above descriptions are exemplary only rather than exhaustive and are not limited to the disclosed embodiments. Many modifications and variations will be apparent to those of ordinary skill in the art without departing from the scope and spirit of the embodiments of the present invention. The selection of the terminologies used herein are intended to best explain the principles of the embodiments, the practical applications or technical improvements to the technologies existing on the market, or to enable others with ordinary skills in the art to understand the embodiments disclosed herein. The scope of the present invention is defined by the appended claims.

1. A method for video content recognition, comprising:
acquiring a target image in a video, said target image selected by a user when the video is being played;
sending a request for video content recognition to a server, wherein the request for video content recognition contains the target image; and
receiving a result of video content recognition from the server, wherein the result of video content recognition comprises information related to the target image and obtained on a search engine.

2. The method according to claim 1, further comprising:
acquiring search engine information that is defined in a client-side apparatus, wherein the search engine information identifies the search engine for searching; and
wherein the request for video content recognition further comprises the search engine information.

3. A method for video content recognition, comprising:
receiving a request for video content recognition from a client-side apparatus, wherein the request for video content recognition contains a target image arbitrarily selected by a user in a video;
acquiring a corresponding result of video content recognition by using a search engine based on the target image; and
sending the result of video content recognition to the client-side apparatus, wherein the result of video content recognition comprises information related to the target image and searched via the search engine.

4. The method according to claim 3, wherein the request for video content recognition further contains search engine information, and the search engine information identifies the search engine to be used for searching.

5. A client-side apparatus for video content recognition, comprising:
an input device for receiving user selection of a target image in a video;
an output device for sending a request for video content recognition to a server, wherein the request for video content recognition contains the target image; and
a receiving device for receiving a result of video content recognition from the server, wherein the result of video content recognition comprises information related to the target image and obtained via search on a search engine.

6. A server-side apparatus for video content recognition, comprising:
an input device for receiving a request for video content recognition from a client-side apparatus, wherein the request for video content recognition contains a target image arbitrarily selected by a user in a video;
one or more processors for acquiring a corresponding result of video content recognition by using a search engine based on the target image; and
an output device for sending the result of video content recognition to the client-side apparatus, wherein the result of video content recognition comprises information related to the target image and obtained using the search engine.
